(19) United States
(12) Patent Application Publication
(10) Pub. No.: US 2018/0210430 A1
(43) Pub. Date: Jul. 26, 2018

(54) Automation System Field Device, Controller and Method for Operating the Automation System for Carrying Out Said Method

(71) Applicant: Siemens Aktiengesellschaft, Muenchen (DE)

(72) Inventors: Jochen Balduf, Hambruecken (DE); Jens Gottron, Karlsruhe (DE); Christoph Weiler, Bretten (DE); Stefan Lueder, Karlsruhe (DE)

(73) Assignee: SIEMENS AKTIENGESELLSCHAFT

(21) Appl. No.: 15/875,425

(22) Filed: Jan. 19, 2018

(30) Foreign Application Priority Data
Jan. 26, 2017 (EP) 17153348

(51) Int. Cl. G05B 19/418

(52) U.S. Cl. CPC G05B 19/4186; G05B 2219/31138; G05B 2219/31229

(57) ABSTRACT

An automation system, a controller, a field device and method for operating the automation system, wherein a first field device is provided for an operation on site with an operating unit, where depending on an operator input, the first field device transmits a request for a provision of data to the controller, which returns to the field device corresponding data relating to functionalities in the automation system lying outside the first field device, and where information corresponding to the data is output on the operating unit of the first field device such that an on-site display in the automation system of existing measurement values that were previously not available on the first field device, or a configuration of automation functions which do not run on the first field device is advantageously permitted.

### BACKGROUND OF THE INVENTION

### 1. Field of the Invention

The invention relates to a method for operating an automation system having at least one controller and a plurality of field devices that are connected to one another by means of a network for data communication. The invention also relates to an automation system, a field device and a controller which are configured to perform the operating method.

### 2. Description of the Related Art

In order to control processes in processing plants, a wide variety of field devices are utilized for the process instrumentation. These field devices are often provided with an operating unit on which, via operator input, for example, the configuration of the unit for its operation within the automation system can be undertaken or process values relating to the field device can be displayed on site. Measuring transducers, often called sensors, serve to detect process variables, such as, temperature, pressure, flow rate, fill level, density or gas concentration of a medium. With controlling elements, also known as actuators, the process operation can be influenced dependent upon detected process variables in accordance with a strategy specified, for example, by a programmable controller or a control station. Examples of controlling elements are a regulating valve, a heater or a pump.

Sensors of the process instrumentation are conventionally used as pure measuring devices that transfer their data, i.e., current values of the process variables detected by them, in an automation system to a higher-level controller. The higher-level controller can be, for example, a programmable controller, also known as an automation device, or can be a cloud application. The processing of the measurement values occurs in the controller to implement, for example, a regulation of a PID controller or to calculate further process values that are derivable from the detected process values and are also often designated soft process values. With a network for data communication, the field devices can be connected directly to the higher-level controller or indirectly thereto via a “remote-IO system”, where the remote-IO system makes a control connection available for each of the field devices. Such a remote-IO system is considered in the present application to be a component of the controller.

Field buses are frequently used as a network for data communication, via which the field devices are connected to the higher-level controller, and operate, for example, according to the protocols PROFIBUS, HART Highway Addressable Remote Transducer (HART) or Foundation Fieldbus (FF). The configuration, activation and monitoring of the automation application that is realized with the automation system is undertaken by means of a control system. Examples are the Supervisory Control and Data Acquisition (SCADA) system, Windows Control Center (WinCC) and process control system (PCS), such as SIMATIC PCS7.

Disadvantageously, it has previously not been possible on a field device of the automation system to call up measurement values detected by other field devices or soft process values calculated at another site of the automation system and to display them to a user or to implement measures for configuring the automation system or to make a change thereto.

### SUMMARY OF THE INVENTION

In view of the foregoing, it is therefore an object of the invention to improve the operability of automation systems.

This and other objects and advantages are achieved in accordance with the invention by a method for operating an automation system, an automation system, a field device and a controller.

Conventionally, on the operating unit of a field device, only the process value detected by the field device itself could be displayed or settings of the configuration and parameterization relating to the field device or its communication could be undertaken. With the novel mode of operation of the automation system, it is now advantageously enabled to display information at a first field device based on data that relates to functionalities lying within the automation system outside the first field device. This can relate, for example, to measurement values that were previously not thus available thereon and originate in the automation system from sources lying outside the first field device. Examples of this are a measurement value that has been detected by a second, other field device, or a so-called soft process value. If other process values that are also detected in the automation system via possibly remotely arranged field devices are also of interest to an operator of the automation system who is currently located at the operating unit of the first field device, it is therefore advantageously no longer required that he leaves his current workplace to fetch the necessary information from another location, for example, the location of the control system or the installation site of the second field device.

In accordance with a particularly advantageous embodiment, the request transmitted by the first field device contains an identification of the data to be provided that is unique at least within the automation system. The use of such a system-wide unambiguous ID (e.g. Universal Resource Identifier (URI)) has the advantage that the request, for example, for a desired measurement value or a configuration parameter is simplified.

In addition or alternatively thereto, it is advantageously enabled by the invention through on-site input into a first field device to configure automation functions of the automation system that do not themselves run on the first field device. Furthermore, automation functions realized on the field device, for example, “Control in the Field” where a regulating process runs in a field device rather than in a higher-level controller, are configurable via input to be performed directly at the field device. For example, in the case of a sensor as the first field device, control in the field can be configured such that, based on its detected process value, it calculates a manipulated variable for an actuator as the second field device and transmits the variable to it. For the configuration of this function, access to parameters of the second field device is required, i.e., to data that relates to functionalities in the automation system situated outside the first field device.

The new mode of operation of the automation system thus enables a flexible operation and monitoring of automation applications at a field device on site. Additional measurement values from other sources of the automation device or soft process values can be called up in the field instrumentation level and displayed. The plant personnel can decide ad hoc how it wishes to access the information belonging to the automation application. The access can occur, as before, via the control system or via a SCADA system or currently also on site at the field devices, such as a sensor or an actuator.

The communication between the field devices and the higher-level controller can occur on the network, for example, with a 4-20 mA interface of the field device with a HART protocol or a field bus of the PROFIBUS PA or foundation field (FF) bus type. These are communication protocols that function according to the master/slave principle and in which it is not per se provided that a field device signals to its control connection via the network, that for realizing a particular functionality, data that relates to functionalities lying in an automation system outside the field device must be provided. To enable such signaling, according to an advantageous embodiment of the invention, a new alarm, a special message or a special response code can be defined that is transmitted in the cyclical master/slave communication from the field device to the controller. At least one of these possibilities is provided via each communication protocol according to the master/slave principle.

The aforementioned use of reserved bits in a HART response code for signaling a request for data initiated by user input at a field device on site is associated with the risk that the same bits are used in future by other users for other purposes. In accordance with an advantageous alternative, for the avoidance of this risk, for example, in a network with a HART protocol, a device variable can be used, via corresponding encoding, to signal a data request. Herein, for example, the following encoding can be used:

0x01=Request for Soft-Sensor Results,
0x02=Application Parameters Changed.

With the HART Cmd 9, up to eight device variables can be requested at once. A HART master polls cyclically with Cmd 9 the values of the device variables of the slaves, i.e., in this case the connected field devices. With this request, the controller cyclically receives, via a network with a HART protocol, for example, from a sensor as the field device, currently detected values of process variables, for example, pressure measurement values and, furthermore, for example, the value encoded in the above form with which, given suitable operator input, a data request can be signaled.

In accordance with a further advantageous exemplary embodiment, with the controller, following recognition of a signaled data request, the application-specific data desired by the field device in the case of a network with a HART protocol is provided via a HART command, for example, a device-specific command or, in the case of a PROFIBUS master, by acyclic PROFIBUS communication to the requesting field device. In an advantageous manner, with these communication mechanisms, data can be transferred both from the controller to the field device and also in the reverse direction. As an alternative possibility, for example, a pre-configured output slot can be used, which is provided for a deterministic PROFIBUS communication. Following receipt of the data request from the field device, the controller then uses the output slot to transfer the requested data deterministically to the field device.

As is made clear by the exemplary disclosed embodiments, no new communications standards need to be developed, because existing mechanisms can be used in a special form. With the new mode of operation, the realization of a multi-sensor system with on-site operability or a soft field device system is enabled, where an implementation of control connections with remote IOs or field distributors represents a scalable solution in an easy manner. If a programmable controller or a remote IO is used for connecting the field devices, sufficient energy is available on the connecting line for supplying the field devices with auxiliary energy and a restriction of the number of connected field devices to two or three, as given for conventional two-conductor systems, is not needed. A further advantage is provided by the possibility of processing values of process variables that are detected with field devices located far apart from one another, in particular also values which are supplied by field devices that are connected at spatially separated connection points to the controller, at an arbitrary site of the automation system, for example in a remote IO or a network component, to a new value. The new mode of operation can advantageously be used as the basis for operating subsystems or modules autonomously, i.e., without a central controller or a control system. It enables the performance of a configuration or a diagnosis of the automation system or parts of the automation system without an engineering or diagnosis tool present in the automation system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiments and advantages of the invention will now be described in greater detail making reference to the drawings in which an exemplary embodiment of the invention is illustrated, in which:

FIG. 1 shows a block circuit diagram of an automation system in accordance with the invention;

FIG. 2 shows different communication sequences; and

FIG. 3 is a flowchart of the method in accordance with the invention.

### DETAILED DESCRIPTION OF THE EXEMPLARY EMBODIMENTS

Similar parts are provided with the same reference signs in the drawings.

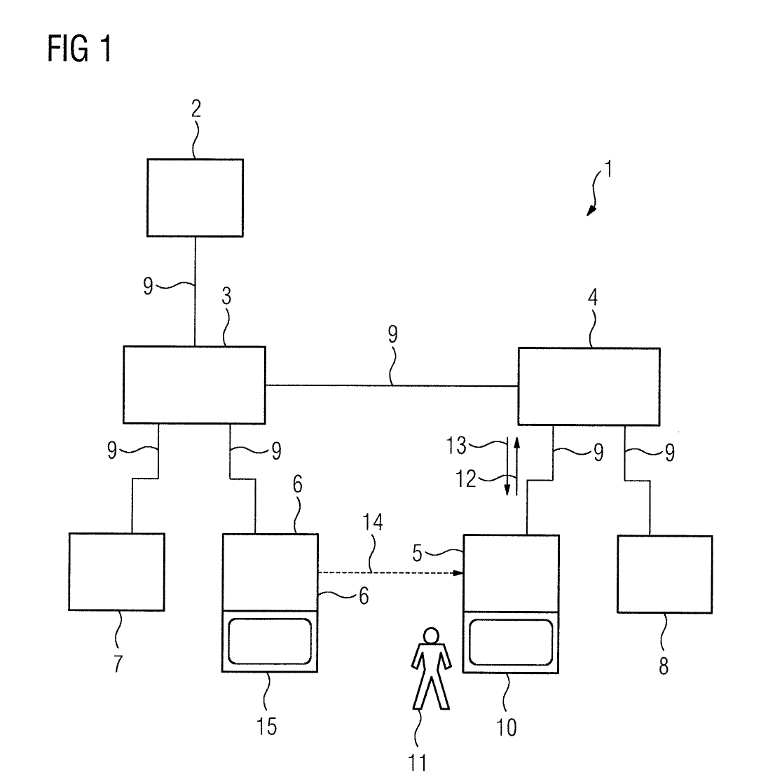

FIG. 1 shows an automation system 1 that is used in an automation system (not shown) to control a process. In the automation system 1, a station 2, a programmable controller 3, a remote IO 4, a first field device 5, a second field device 6, a third field device 7 and a fourth field device 8 are connected to one another by a network 9 for data communication. The network 9 can be an arbitrary industrial network, for example, with PROFIBUS, PROFINET, HART or FF protocol. For the individual connections that exist between the specified components in the network 9, different communication standards, which differ in the respective physical transmission technique and/or the respective communication protocol, can naturally be used in the same network 9.

Together, the programmable controller 3 and the remote-IO 4 form a controller at a higher-level from the field devices 5 . . . 8. The first field device 5 is provided with an operating unit 10, the second field device 6 is provided with an operating unit 15 at which an operator 11 can make inputs and on which information concerning the automation system 1 can be output. Self-evidently, the further field devices 7 and 8 can also be provided with operating units (not shown in the drawings).

In conventional automation systems, their engineering, configuration and operation was only possible via the station 2 and not via, for example, one operating unit 10 which, as shown in the exemplary embodiment of FIG. 1, is associated with the field device 5. In order to now also enable a configuration and operation of the automation system 1 via the operating unit 10, a new mode of operation of the automation system is introduced. If the operator 11 wishes to access data that relates to functionalities in the automation system 1 outside the first field device 5 by operating the first field device 5, a corresponding request, indicated in FIG. 1 by an arrow 12, is sent to the remote IO 4, where the request can be provided with a unique identifier of the desired data within the automation system (1). This is answered by the remote IO 4 with the provision of the requested data, symbolized by the arrow 13. In this way, for example, process values detected by the second field device 6 that are known to the controller can be displayed on the operating unit 10. This is indicated in FIG. 1 with a dashed arrow 14.

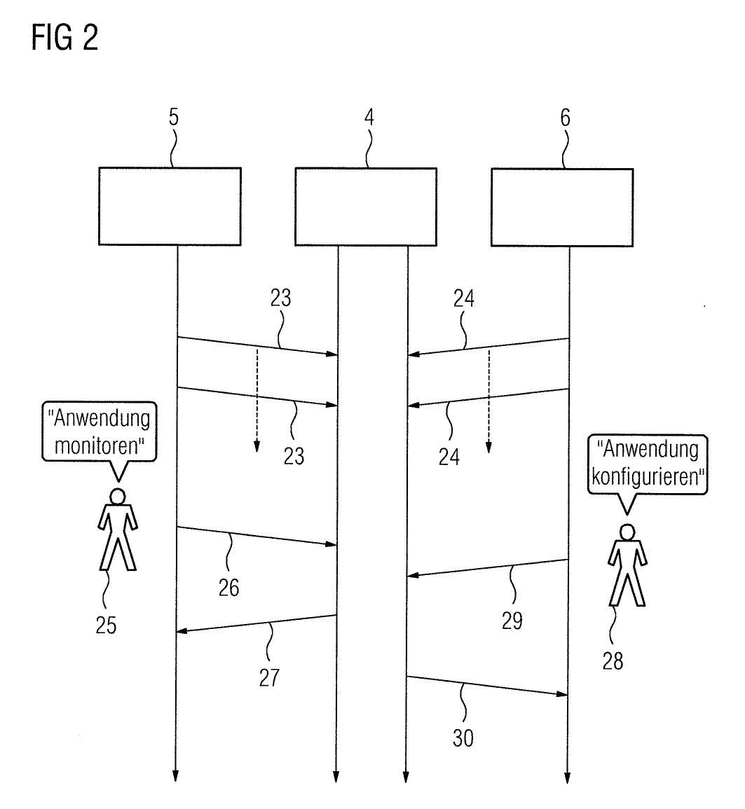

The new mode of operation described above for monitoring the application running on the automation system 1, here specifically for displaying a process value detected outside the first field device 5, is based on a communication sequence, which is described in greater detail below, making reference to FIG. 2, together with a further communication sequence which is suitable for the configuration of the application.

Shown in FIG. 2 on the left side, as already referred to above, is the communication sequence between the first sensor 5 and the remote IO 4 as part of the controller, and on the right side, a communication sequence between the second sensor 6 and the controller (remote IO 4). During normal operation of the system, which is controlled by the automation system, the process values detected respectively by the first sensor 5 and the second sensor 6 are cyclically transferred to the controller, as symbolized in FIG. 2 with arrows 23 and 24. Taking the example of a 4-20 mA interface with a HART protocol, this can occur, for example with the HART Cmd 1, making use of a HART response code. In the application which runs in the controller, the obtained process values are used, for example, for calculating further soft process values or for calculating manipulated variables with which intervention in the operation of the system occurs. If monitoring of the application is now to be performed by an operator 25 on the first sensor 5, then following suitable operator input (“monitor application”) at the operating unit 10 (FIG. 1) of the first sensor 5, the wish for an on-site display, for example, in the response code to the HART Cmd 1, is signaled to the controller, as is symbolically represented in FIG. 2 by an arrow 26. The data corresponding to the received request, in the example described, the value of a process variable currently detected by the second sensor 6 or a soft process value calculated in the controller from a plurality of received process values, is thereafter transmitted by the controller in accordance with an arrow 27 to the first sensor 5 on the operating unit of which the information previously desired by the operator 25 is displayed.

If an operator 28 wishes to implement on the second sensor 6, for example, measures for changing the configuration of the automation system, then he undertakes a corresponding input (“configure application”) at the operating unit 15 (FIG. 1) of the second field device 6 and in the response code to the HART Cmd 1, the wish for an on-site operation is signaled (as indicated by an arrow 29 in FIG. 2) to the controller. By subsequent polling using the device-specific HART command, the desired configuration parameters can be transferred from the controller to the second sensor 6. This is symbolized by an arrow 30 in FIG. 2.

Alternatively to the use of the HART Cmd 1 described above, the cyclic transfer of the process values is naturally also possible using the HART Cmd 9. The signaling of an on-site display by the first sensor 5 or the signaling of a desired on-site operation by the second sensor 6 can also occur with the use of a HART device variable which, in addition to the respective process value, is requested by the controller via HART Cmd 9.

With the aid of the communication sequences shown in FIG. 2, measurement values that initially were not available on the first sensor 5 can be displayed on the first sensor 5 in an advantageous manner. Furthermore, by undertaking operating inputs at the second sensor 6, automation functions that do not occur on the second sensor 6 can be configured. In order to provide this operating possibility, with the aid of the communication sequences shown, data that relates to functionalities lying outside the sensors 5 and 6 in the automation system is made available to the first sensor 5 or the second sensor 6. Naturally, the communication sequence described based on the second sensor 6 can also be performed with the first sensor 5 and the communication sequence described based on the first sensor 5 can also be performed with the second sensor 6.

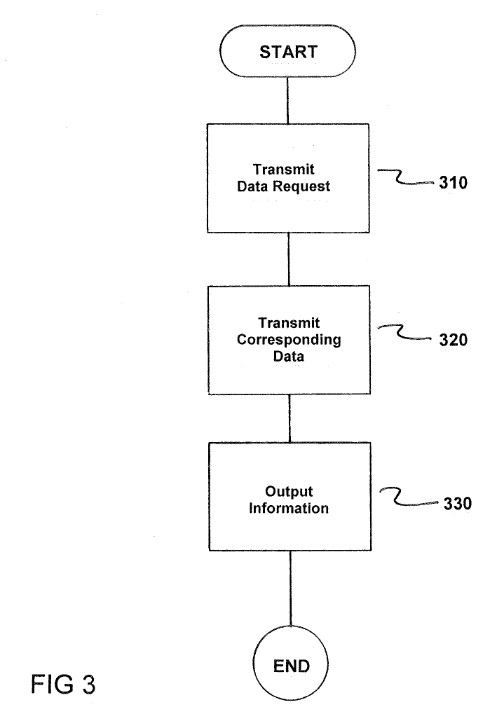

FIG. 3 is a flowchart of a method for operating an automation system 1 having at least one controller 3, 4 and a plurality of field devices 5 . . . 8 interconnected via a network 9 for data communication, where at least one first field device 5 of the plurality of field devices 5 . . . 8 includes an operating unit 10.

The method comprises transmitting, by the at least one first field device 5, depending upon a pre-determined or pre-determinable operator input, a request to the controller 3, 4 for a provision of data relating to functionalities lying outside the at least one first field device in the automation system 1, as indicated in step 310.

Next, the controller 3, 4 transmits corresponding data according to the received request to the at least one first field device 5, as indicated in step 320.

An item of information corresponding to the received data on the operating unit 10 is now output the at least one first field device 5, as indicated in step 330.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating an automation system having at least one controller and a plurality of field devices interconnected via a network for data communication, at least one first field device of the plurality of field devices including an operating unit, the method comprising:
transmitting, by the at least one first field device, depending upon a pre-determined or pre-determinable operator input, a request to the controller for a provision of data relating to functionalities lying outside the at least one first field device in the automation system;
transmitting, by the controller, corresponding data according to the received request to the at least one first field device; and
outputting, by the at least one first field device, an item of information corresponding to the received data on the operating unit.

2. The method as claimed in claim 1, wherein the request transmitted by the at least one first field device contains an identification of the data to be provided which is unique, at least within the automation system.

3. The method as claimed in claim 1, wherein the item of information is a process value which has been detected by one of (i) a second, other field device and (ii) another soft process value calculated from detected process values.

4. The method as claimed in claim 2, wherein the item of information is a process value which has been detected by one of (i) a second, other field device and (ii) another soft process value calculated from detected process values.

5. The method as claimed in claim 1, wherein the item of information relates to a configuration of the automation system.

6. The method as claimed in claim 1, wherein the transmission of the request via the network occurs with one of (i) a pre-determined alarm, (ii) a pre-determined message and (iii) a pre-determined response code.

7. The method as claimed in claim 1, wherein the transmission of the request via the network occurs with a pre-determined code for a device variable.

8. The method as claimed in claim 2, wherein the transmission of the request via the network occurs with a pre-determined code for a device variable.

9. The method as claimed in claim 3, wherein the transmission of the request via the network occurs with a pre-determined code for a device variable.

10. The method as claimed in claim 5, wherein the transmission of the request via the network occurs with a pre-determined code for a device variable.

11. The method as claimed in claim 6, wherein the transmission of the data according to the received request occurs via one of (i) HART Cmd, (ii) acyclic PROFIBUS communication and (iii) a pre-configured output slot via deterministic PROFIBUS communication.

12. The method as claimed in claim 7, wherein the transmission of the data according to the received request occurs via one of (i) HART Cmd, (ii) acyclic PROFIBUS communication and (iii) a pre-configured output slot via deterministic PROFIBUS communication.

13. An automation system comprising:
at least one controller; and
a plurality of field devices interconnected via a network for data communication, at least one first field device of the plurality of field devices including an operating unit;
wherein the at least one first field device is configured to transmit a request to the controller for a provision of data relating to functionalities in the automation system lying outside the first field device, depending upon a pre-determined or pre-determinable operator input;
wherein the controller is configured to transmit data corresponding to the received request to the first field device; and
wherein the at least one first field device is further configured to output an item of information corresponding to the received data on the operating unit.

14. A field device for an automation system, comprising:
an operating unit;
wherein the field device is configured to transmit a request to the controller for provision of data relating to functionalities in the automation system lying outside at least one first field device, depending upon a pre-determined or pre-determinable operator input, receive data from a controller corresponding to the request and to output an item of information corresponding to the received data on the operating unit.

15. A controller for an automation system, wherein the controller is configured to receive a request from at least one first field device including an operating unit, depending upon a pre-determined or pre-determinable operator input, for provision of data which relates to functionalities in the automation system lying outside the at least one first field device and to transmit data to the at least one first field device data corresponding to the received request.
